(19) United States
(12) Patent Application Publication
(10) Pub. No.: US 2026/0099526 A1
(43) Pub. Date: Apr. 9, 2026

(54) MACHINE LEARNING-BASED QUERY PROCESSING OF DOCUMENTS BASED ON DOCUMENT FORMATTING OF TEXTUAL ELEMENTS

(71) Applicant: Dell Products L.P., Round Rock, TX (US)

(72) Inventors: Shaul Dar, Petach Tikva (IL); Ramakanth Kanagovi, Hyderabad (IN); Guhesh Swaminathan, Chennai (IN); Rajan Kumar, Nawada (IN)

(21) Appl. No.: 18/908,334

(22) Filed: Oct. 7, 2024

(51) Int. Cl. G06F 16/33; G06F 16/332; G06F 40/186

(52) U.S. Cl. CPC G06F 16/3344; G06F 16/3329; G06F 40/186

(57) ABSTRACT

An apparatus comprises at least one processing device configured to obtain a query comprising search text and a context identifying documents to be searched. The processing device is also configured to generate document chunks by parsing the documents, each document chunk comprising a portion of content of the documents, and to determine chunk boosting factors for the document chunks based on document formatting of textual elements within the document chunks. The processing device is further configured to select a subset of the document chunks based on determining a similarity between content of the document chunks and the search text using the determined chunk boosting factors, to generate a prompt for input to a machine learning system comprising the selected subset of the document chunks, to apply the prompt to the machine learning system, and to provide an answer to the query based on an output of the machine learning system.

### BACKGROUND

As the value and use of information continues to increase, individuals and businesses seek additional ways to process and store information. Information processing systems may be used to process, compile, store and communicate various types of information. Because technology and information processing needs and requirements vary between different users or applications, information processing systems may also vary (e.g., in what information is processed, how the information is processed, how much information is processed, stored, or communicated, how quickly and efficiently the information may be processed, stored, or communicated, etc.). Information processing systems may be configured as general purpose, or as special purpose configured for one or more specific users or use cases (e.g., financial transaction processing, airline reservations, enterprise data storage, global communications, etc.). Information processing systems may include a variety of hardware and software components that may be configured to process, store, and communicate information and may include one or more computer systems, data storage systems, and networking systems. Various search algorithms may be used for searching the information stored in information processing systems.

### SUMMARY

Illustrative embodiments of the present disclosure provide techniques for machine learning-based query processing of documents based on document formatting of textual elements.

In one embodiment, an apparatus comprises at least one processing device comprising a processor coupled to a memory. The at least one processing device is configured to obtain a query, the query comprising search text and a context, the context identifying one or more documents to be searched using the search text. The at least one processing device is also configured to generate a plurality of document chunks by parsing the one or more documents, each of the plurality of document chunks comprising a portion of content of one of the one or more documents. The at least one processing device is further configured to determine one or more chunk boosting factors for at least a subset of the plurality of document chunks, the one or more chunk boosting factors being determined based at least in part on document formatting of textual elements within the subset of the plurality of document chunks. The at least one processing device is further configured to select a subset of the plurality of document chunks based at least in part on determining a similarity between content of the plurality of document chunks and the search text, the determined similarity being based at least in part on the determined one or more chunk boosting factors for the subset of the plurality of document chunks. The at least one processing device is further configured to generate, based at least in part on the query, a prompt for input to a machine learning system, the prompt comprising the selected subset of the plurality of document chunks, to apply the prompt to the machine learning system to generate an output, and to provide an answer to the query based at least in part on the output of the machine learning system.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based query processing of documents based on document formatting of textual elements in an illustrative embodiment.

FIG. 2 is a flow diagram of an exemplary process for machine learning-based query processing of documents based on document formatting of textual elements in an illustrative embodiment.

FIG. 3 shows a table of formatting tags and associated boosting factors for boosting chunk embeddings in an enhanced retrieval augmented generation approach in an illustrative embodiment.

FIG. 4 shows an example portion of a document with different portions associated with different formatting tags in an illustrative embodiment.

FIG. 5 shows a system flow for implementing an enhanced retrieval augmented generation approach with formatting-based boosted chunk embeddings for querying a large language model in an illustrative embodiment.

FIGS. 6A-6C show an example of query processing with chunk selections utilizing a retrieval augmented generation approach in an illustrative embodiment.

FIGS. 7A-7D show an example of query processing with chunk selections utilizing an enhanced retrieval augmented generation approach with formatting-based boosted chunk embeddings in an illustrative embodiment.

FIGS. 8A and 8B show another example of query processing with chunk selections utilizing a retrieval augmented generation approach in an illustrative embodiment.

FIGS. 9A and 9B show another example of query processing with chunk selections utilizing an enhanced retrieval augmented generation approach with formatting-based boosted chunk embeddings in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

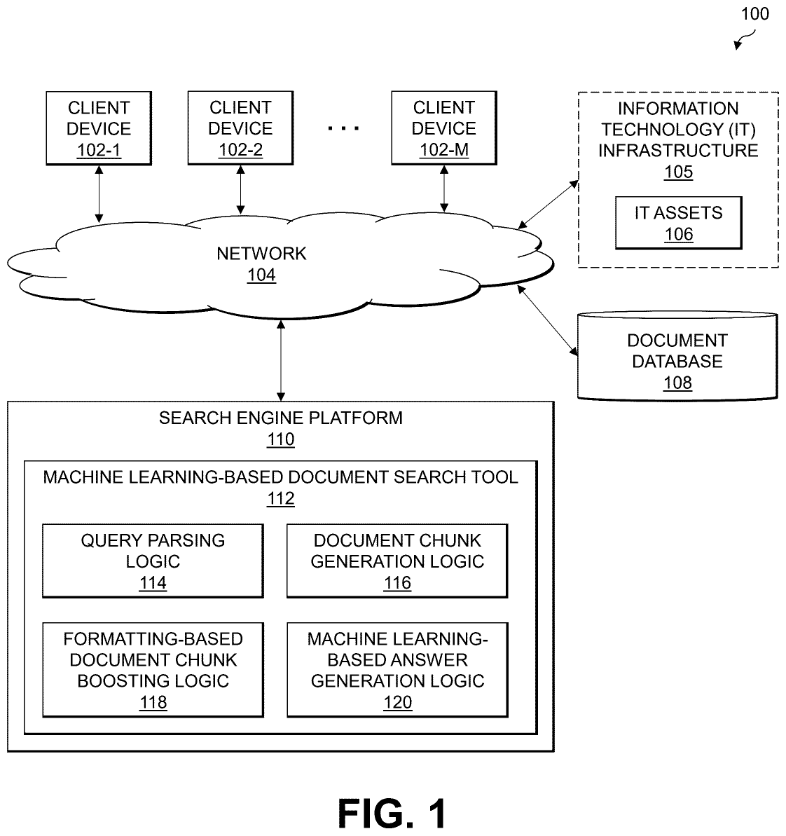

FIG. 1 shows an information processing system 100 configured in accordance with an illustrative embodiment. The information processing system 100 is assumed to be built on at least one processing platform and provides functionality for machine learning-based query processing of documents based on document formatting of textual elements. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a document database 108, and a search engine platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the search engine platform 110 is used for an enterprise system. For example, an enterprise may subscribe to or otherwise utilize the search engine platform 110 for performing searches or queries related to documents stored in the document database 108, documents produced by or otherwise related to operation of the IT assets 106 of the IT infrastructure 105, etc. For example, users of the client devices 102 may submit searches or queries to the search engine platform 110 to perform intelligent searching of documents from the document database 108, where such documents may but are not required to be produced by or otherwise associated with operation of the IT assets 106 of the IT infrastructure 105. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The document database 108 is configured to store and record various information that is utilized by the search engine platform 110 and the client devices 102. Such information may include, for example, information that is collected regarding operation of the IT assets 106 of the IT infrastructure 105 (e.g., support tickets, logs, etc.). The search engine platform 110 may be utilized by the client devices 102 to perform searches of such information in order to perform troubleshooting and remediation of issues encountered on the IT assets 106 of the IT infrastructure 105. The document database 108 may also or alternatively store information regarding technical guides, support documents, etc. relating to configuration and operation of the IT assets 106 of the IT infrastructure 105. The client devices 102 may utilize the search engine platform 110 to query such technical guides, support documents, etc. to assist in performing configuration of the IT assets 106 of the IT infrastructure 105, to perform troubleshooting and remediation of issues encountered on the IT assets 106 of the IT infrastructure 105. The document database 108 may also store any documents or other information that is desired to be searched utilizing the search engine platform 110, including information that is unrelated to the IT assets 106 of the IT infrastructure 105.

The document database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the search engine platform 110, as well as to support communication between the search engine platform 110 and other related systems and devices not explicitly shown.

The search engine platform 110 may be provided as a cloud service that is accessible by one or more of the client devices 102 to allow users thereof to perform searching of a set of input documents, including documents that contain various text formatting. The client devices 102 may be configured to access or otherwise utilize the search engine platform 110 (e.g., to perform searches, including searches related to configuration of the IT assets 106 of the IT infrastructure 105, operation of the IT assets 106 of the IT infrastructure 105, issues encountered on the IT assets 106 of the IT infrastructure 105, troubleshooting and remediation of issues encountered on the IT assets 106 of the IT infrastructure 105, etc.). In some embodiments, the client devices 102 are assumed to be associated with software developers, system administrators, IT managers or other authorized personnel responsible for managing the IT assets 106 of the IT infrastructure 105. In some embodiments, the IT assets 106 of the IT infrastructure 105 are owned or operated by the same enterprise that operates the search engine platform 110. In other embodiments, the IT assets 106 of the IT infrastructure 105 may be owned or operated by one or more enterprises different than the enterprise which operates the search engine platform 110 (e.g., a first enterprise provides search functionality support for multiple different customers, businesses, etc.). Various other examples are possible.

In some embodiments, the client devices 102 and/or the IT assets 106 of the IT infrastructure 105 may implement host agents that are configured for automated transmission of information with the document database 108 and the search engine platform 110 regarding searches (e.g., queries, answers to queries, etc.). It should be noted that a “host agent” as this term is generally used herein may comprise an automated entity, such as a software entity running on a processing device. Accordingly, a host agent need not be a human entity.

The search engine platform 110 in the FIG. 1 embodiment is assumed to be implemented using at least one processing device. Each such processing device generally comprises at least one processor and an associated memory, and implements one or more functional modules or logic for controlling certain features of the search engine platform 110. In the FIG. 1 embodiment, the search engine platform 110 implements a machine learning-based document search tool 112. The machine learning-based document search tool 112 comprises query parsing logic 114, document chunk generation logic 116, formatting-based document chunk boosting logic 118, and machine learning-based answer generation logic 120. The query parsing logic 114 is configured to obtain queries, where a given query comprises search text and a context, the context identifying one or more documents (e.g., from the document database 108) to be searched using the search text. The one or more documents are assumed to include at least one document that uses text with different formatting (e.g., heading styles, font size, emphasis, color, lists, including designated keywords, etc.). The document chunk generation logic 116 is configured to generate a plurality of document chunks by parsing the one or more documents. Each of the plurality of document chunks comprises a portion of content of one of the one or more documents. The formatting-based document chunk boosting logic 118 is configured to determine boosting factors to be applied to different ones of the plurality of document chunks based at least in part on the formatting of text within each of the plurality of document chunks. The machine learning-based answer generation logic 120 is configured to select a subset of the plurality of document chunks based at least in part on determining a similarity between content of the plurality of document chunks and the search text, taking into account the boosting factors determined by the formatting-based document chunk boosting logic 118. The machine learning-based answer generation logic 120 is also configured to generate, based at least in part on the query, a prompt for input to a machine learning system (e.g., a large language model (LLM)), the prompt comprising the selected subset of the plurality of document chunks. The machine learning-based answer generation logic 120 is further configured to apply the prompt to the machine learning system to generate an output, and to provide an answer to the query based at least in part on the output of the machine learning system.

At least portions of the machine learning-based document search tool 112, the query parsing logic 114, the document chunk generation logic 116, the formatting-based document chunk boosting logic 118, and the machine learning-based answer generation logic 120 may be implemented at least in part in the form of software that is stored in memory and executed by a processor.

It is to be appreciated that the particular arrangement of the client devices 102, the IT infrastructure 105, the document database 108 and the search engine platform 110 illustrated in the FIG. 1 embodiment is presented by way of example only, and alternative arrangements can be used in other embodiments. As discussed above, for example, the search engine platform 110 (or portions of components thereof, such as one or more of the machine learning-based document search tool 112, the query parsing logic 114, the document chunk generation logic 116, the formatting-based document chunk boosting logic 118, and the machine learning-based answer generation logic 120) may in some embodiments be implemented internal to the IT infrastructure 105.

The search engine platform 110 and other portions of the information processing system 100, as will be described in further detail below, may be part of cloud infrastructure.

The search engine platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the document database 108 and the search engine platform 110 or components thereof (e.g., the machine learning-based document search tool 112, the query parsing logic 114, the document chunk generation logic 116, the formatting-based document chunk boosting logic 118, and the machine learning-based answer generation logic 120) may be implemented on respective distinct processing platforms, although numerous other arrangements are possible. For example, in some embodiments at least portions of the search engine platform 110 and one or more of the client devices 102, the IT infrastructure 105, the IT assets 106 and/or the document database 108 are implemented on the same processing platform. A given client device (e.g., 102-1) can therefore be implemented at least in part within at least one processing platform that implements at least a portion of the search engine platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the document database 108 and the search engine platform 110, or portions or components thereof, to reside in different data centers. Numerous other distributed implementations are possible. The search engine platform 110 can also be implemented in a distributed manner across multiple data centers.

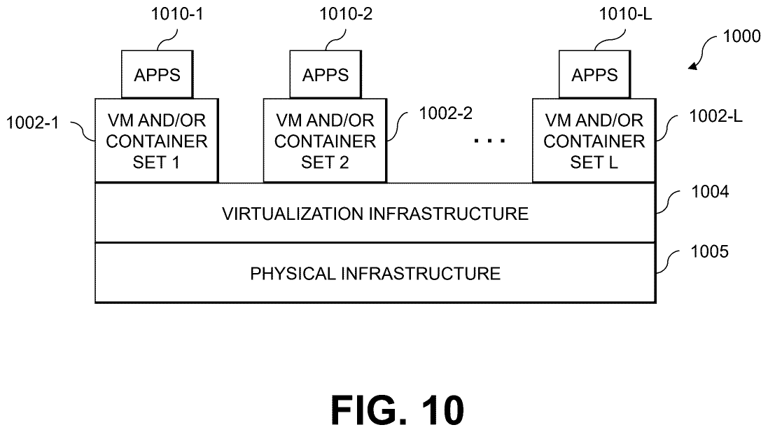

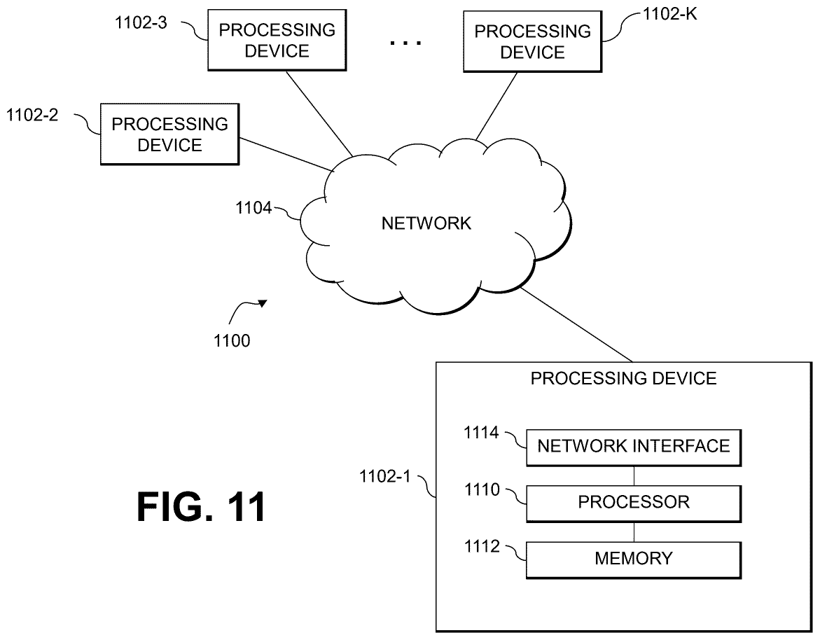

Additional examples of processing platforms utilized to implement the search engine platform 110 and other components of the information processing system 100 in illustrative embodiments will be described in more detail below in conjunction with FIGS. 10 and 11.

It is to be understood that the particular set of elements shown in FIG. 1 for machine learning-based query processing of documents based on document formatting of textual elements is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

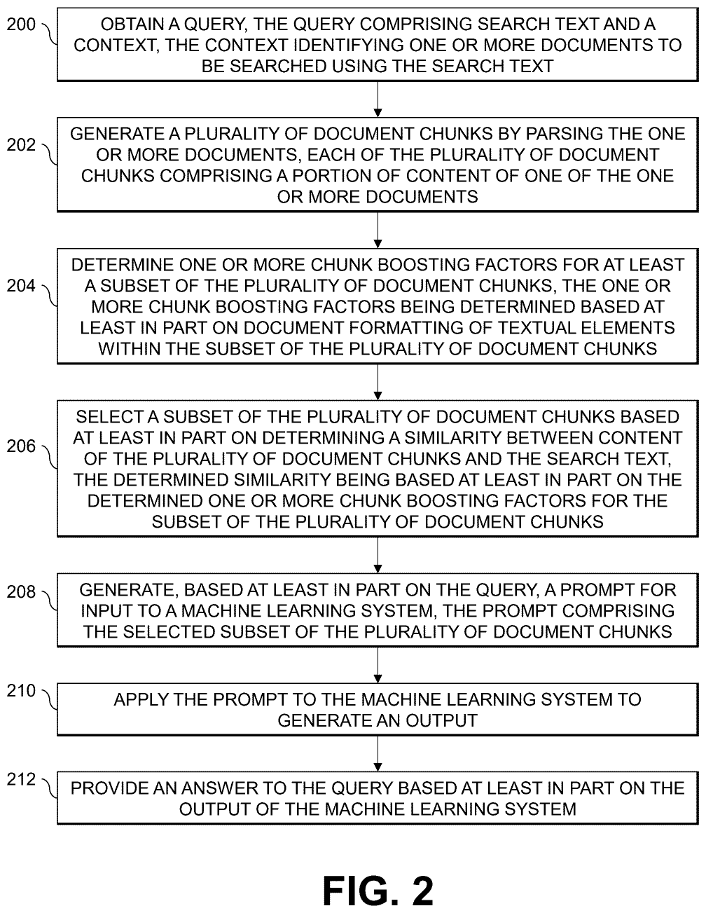

An exemplary process for machine learning-based query processing of documents based on document formatting of textual elements will now be described in more detail with reference to the flow diagram of FIG. 2. It is to be understood that this particular process is only an example, and that additional or alternative processes for machine learning-based query processing of documents based on document formatting of textual elements may be used in other embodiments.

In this embodiment, the process includes steps 200 through 212. These steps are assumed to be performed by the search engine platform 110 utilizing the machine learning-based document search tool 112, the query parsing logic 114, the document chunk generation logic 116, the formatting-based document chunk boosting logic 118 and the machine learning-based answer generation logic 120. The process begins with step 200, obtaining a query, the query comprising search text and a context, the context identifying one or more documents to be searched using the search text. The query may be directed to performing configuration of an IT asset, and the one or more documents may comprise one or more technical guides for the IT asset. The query may alternatively be directed to performing at least one of troubleshooting and remediation of one or more issues encountered on an IT asset, and the one or more documents may comprise one or more support tickets associated with the one or more issues encountered on the IT asset.

In step 202, a plurality of document chunks are generated by parsing the one or more documents. Each of the plurality of document chunks comprises a portion of content of one of the one or more documents.

In step 204, one or more chunk boosting factors are determined for at least a subset of the plurality of document chunks. The one or more chunk boosting factors are determined based at least in part on document formatting of textual elements within the subset of the plurality of document chunks. The one or more chunk boosting factors may be associated with: at least one of a heading style, a font size, text emphasis and text color of textual elements; textual elements that are part of a numbered or bulleted list; and textual elements containing one or more designated keywords. The one or more chunk boosting factors may be further determined based at least in part on named entity recognition in the textual elements within the subset of the plurality of document chunks.

A given document chunk in the subset of document chunks may comprise two or more textual elements each associated with at least one document formatting-based textual element boosting factor, the one or more chunk boosting factors for the given document chunk being based at least in part on a combination of the document formatting-based textual element boosting factors of the two or more textual elements in the given document chunk. A given one of the two or more textual elements in the given document chunk may be associated with two or more document formatting-based textual element boosting factors.

In some embodiments, the one or more chunk boosting factors are based at least in part on frequencies of different types of document formatting of textual elements in the one or more documents. The one or more chunk boosting factors may be document-specific for a given one of the one or more documents. The one or more chunk boosting factors may be document-specific for the given document responsive to determining that frequencies of different types of document formatting of textual elements in the given document exhibit at least a threshold difference from frequencies of the different types of document formatting of textual elements in one or more other ones of the one or more documents.

The one or more chunk boosting factors utilized for a given one of the one or more documents may be based at least in part on at least one of an entity that produced the given document and a document type of the given document.

In step 206, a subset of the plurality of document chunks are selected based at least in part on determining a similarity between content of the plurality of document chunks and the search text. The determined similarity is based at least in part on the determined one or more chunk boosting factors for the subset of the plurality of document chunks.

In step 208, a prompt for input to a machine learning system is generated based at least in part on the query. The prompt comprises the selected subset of the plurality of document chunks.

In step 210, the prompt is applied to the machine learning system to generate an output. The machine learning system may comprise an LLM.

In step 212, an answer to the query is provided based at least in part on the output of the machine learning system.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Large Language Models (LLMs), such as the OpenAI Chat Generative Pre-Trained Transformer (ChatGPT) model, are a type of machine learning model that can provide a better alternative to traditional search engines in helping users find pieces of information that they are looking for, and in providing more concise and relevant answers, albeit with a risk that the answers may be irrelevant or incorrect. The query that a user types is given as input to the LLM, along with an appropriate context, which is the text that the LLM should “search” for an answer. This is referred to as prompt engineering. A problem with this approach is that the size of the prompt is limited. For example, the limit for GPT3.5-Turbo is 4,096 tokens, and for GPT4 it is 8,192 tokens. The input documents can often be orders of magnitude larger than this limit. For example, a user may utilize an LLM to query product guides for IT assets, where the product guides are orders of magnitude larger than such limits (e.g., tens or hundreds of pages). Thus, an approach referred to as Retrieval Augmented Generation (RAG) may be used to break the input documents into chunks that are small enough to fit the prompt size limitations. For a given query, RAG attempts to combine the most relevant chunks together with the query as the input prompt to the LLM, which presents answers to the user.

Conventional RAG approaches, when used in practice, often produce results that are disappointing. The answers provided by the LLM may be wrong or irrelevant, phrased incorrectly, or even “made up” (hallucinations). This is due to various reasons, including a bad chunking methodology, a poor match between the query and chunks, etc., which causes the context presented to the LLM to be based on incorrect content chunks resulting in wrong answers. Thus, the information retrieval stage in the process (e.g., effective chunking, chunk indexing, chunk selection based on a similarity search for a small set of chunks out of thousands and potentially millions of chunks, etc.) may have a much greater impact than the final LLM stage.

A major challenge with RAG is how to perform the chunking, indexing and matching effectively such that the LLM output at the end of the process will provide correct and useful answers. In some embodiments, techniques may be used which are based on comprehension of the input document's structure (e.g., the Document Object Model (DOM) of a document). Such an approach can greatly improve the relevance of the chunks and the match between queries and the chunks, thus improving the overall quality of the question answering process and user satisfaction.

An additional limitation or challenge of conventional RAG approaches is that it treats all text elements (e.g., words) in a source document equally, ignoring important “hints” such as headings, text format and emphasis, indicative keywords, etc. As discussed above, the document structure (e.g., the DOM of a document) may be used to guide the chunking process, including creating special indices for document headings.

Illustrative embodiments provide technical solutions for an enhanced RAG approach that incorporates document formatting comprehension. The enhanced RAG approach is configured to determine relevant content tags for text elements in a completely automated and customized manner, such that not all text elements in a source document are treated equally. Instead, particular document chunks of a source document may be “boosted” based on the formatting of text elements within the document chunks, where the formatting may include, for example, heading style, font size, emphasis (e.g., underline, bold, italics, plain), color, whether text elements are part of a list (e.g., a numerical list, a bulleted list), whether text elements represent designated keywords (e.g., warning, caution, note, etc.), etc.

In some embodiments, the technical solutions described herein utilize enhanced RAG with document formatting comprehension. The document formatting comprehension advantageously takes into account document structure, text format and special indicators to tag content with relevant metadata (e.g., content formatting tags). Customized boosting weights are applied to different document chunks based on the content formatting tags of the textual content within the document chunks. The overall boosting weight for a document chunk may be based on a combination of boosting weights for multiple content formatting tags of the textual content within that document chunk. The boosting weights for the document chunks are used to create “biased” vector embeddings for the document chunks to reflect the desired boosts. Various methods may be used to assign boosting weights, including the use of search engine conventions, frequency in a current document, frequency in an entire document corpus, using semantic tags such as Named Entity Recognition (NER), user-adjustable or user-customizable, etc.

Conventional or default RAG chunking and indexing methodologies treat all text elements (e.g., words) in a document chunk equally. Some text elements in documents, however, are more important than others and thus should be given a greater weight. Such text elements include those with specific document formatting, including document structure, text format and special keywords. Document structure elements include, for example, headings (e.g., chapter and section headings) in various levels (e.g., H1, H2, H3, etc.), numbered and bulleted lists, image and table captions, etc. Text format elements includes, for example, font family, size and color, emphasis such as bold, underline, italics, etc. Special keyword elements include, for example, designated keywords such as “Note,” “Warning,” “Caution,” etc.

Local and global search engines such as ElasticSearch and Google take certain tags into consideration. For example, the “strong” and “em” HyperText Markup Language (HTML) tags were created specifically to provide hints to web search engines to draw attention to text phrases marked with these tags (e.g., through Search Engine Optimization (SEO)). ElasticSearch allows a user to manually “boost” certain text fields in a document. Illustrative embodiments utilize formatting-based document chunk boosting (e.g., based on document structure elements, text format elements, special keyword elements, etc.) within an RAG architecture and use vector embeddings to actualize the desired boosting for different document chunks. Thus, the technical solutions described herein provide a generalized and automated framework for document formatting comprehension-based boosting specification and customization, including boosting based on combinations of boost factors.

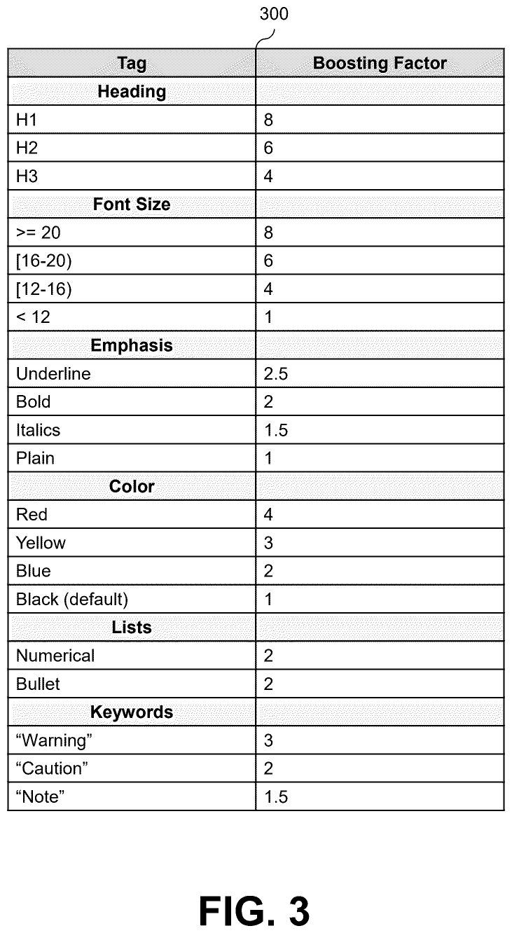

The document formatting comprehension-based boosting methodology used in some embodiments will now be described, which applies customized boosting weights to different content formatting tags associated with text elements of document chunks. For case of illustration, it is assumed that text without any special tags (e.g., normal paragraph text) is assigned a default weight (e.g., 1), and the various kinds of special content formatting tags are assigned a “boost” multiplier (e.g., in the range of [1-10]). FIG. 3 shows a table 300 showing example boosting factors for different special content formatting tags including heading styles, font size, emphasis (e.g., underline, bold, italics, plain), color (e.g., red, yellow, blue, black/default), lists (e.g., numerical, bulleted), and special keywords (e.g., warning, caution, note). These default boosting values, or user-customized boosting values, may be stored in a configuration file and used by a document formatting comprehension-based boosting algorithm. Various techniques may be used to automatically calculate the boosting factors for a given set of documents (e.g., an RAG dataset).

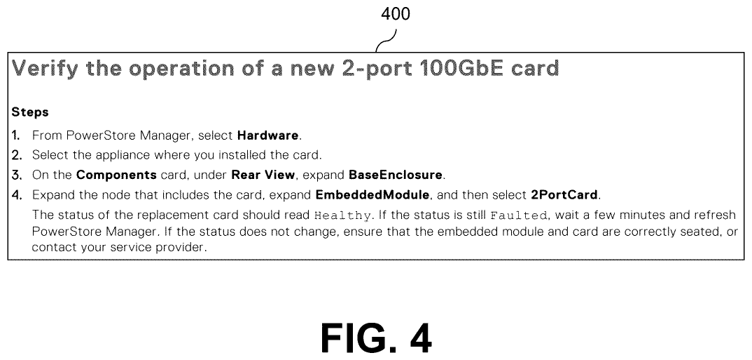

In some embodiments, the document formatting comprehension-based boosting methodology may combine the boosting weights of multiple content formatting tags associated with text elements within a document chunk. FIG. 4 shows an example document chunk 400 taken from a Dell PowerStore User Guide. In the document chunk 400, the text “Verify the operation of a new 2-port 100 GbE card” is boosted for being a heading (H2 level), as well as having large font, a different color (blue, represented in grayscale in the figure), and bold emphasis. The text “2PortCard” is boosted for being part of a numbered list, as well as having bold emphasis. Various approaches may be used to combine the weights of such overlapping content formatting tags. One approach is to use simple addition of the weights. Another approach is to use the following formula, where k is the number of content formatting tags applied to a certain text element and Wᵢ, for i=1 . . . k are the individual weights:

$$W = 10 * ( 1 - {\prod }_{i = 1}^{k} ( 1 - {W}_{i} / 10 ) )$$

For example, if a given text element is tagged with content formatting tags having boost factors of 8, 5 and 2, the total or overall boost for the text element would be 9.2. This formula has various desirable properties, including that it is agnostic to the order of the weights, that it assigns greater weight to the most prominent boosting factors, and that it yields a normalized value in the range [1-10]. It should be noted, however, that other combination formulas may be used in other embodiments. Further, some cases may ignore certain overlapping boost factors. For example, certain heading styles often use larger font sizes, and thus some embodiments may opt to ignore the font size boosting for headings. Such policies may be specified in the document formatting comprehension-based boosting value configuration file.

The boosting values are used to create boosted vector embeddings for document chunks. After each text element (e.g., each word) in a document chunk is assigned all its relevant content formatting tags, the respective boosting factors or weights for those content formatting tags are retrieved from the document formatting comprehension-based boosting value configuration file (e.g., the table 300 of FIG. 3). The total boost factor for each text element is then calculated (e.g., using the formula described above). Boosted vector embeddings are then generated for each text element. The final embedding for the complete document chunk is then calculated according to:

$${CE}_{k} = \frac{( B {w}_{1} * E {w}_{I} + B {w}_{2} * E {w}_{2} + … + B {w}_{n} * E {w}_{n} )}{( B {w}_{1} + B {w}_{2} + … + B {w}_{n} )}$$

where CEₖ is the embedding value for document chunk k, Bwᵢ is the total boost factor for the ith text element (e.g., word) in the document chunk k, and Ewᵢ is the initial embedding value for the ith text element (e.g., word) in the document chunk k.

In some embodiments, different methods are used to assign boosting factors based on the organization that produced the documents, the document type, etc. While the table 300 of FIG. 3 shows an example of “default” boosting factors for various content formatting tags, different organization and document types (e.g., user manuals, knowledge base articles, GitHub code and documentation repositories, support tickets, etc.) may exhibit a wide spectrum of structure and formatting conventions. Thus, customizable methods may replace or augment the default boosting policies based on knowledge of the structure and formatting conventions of specific documents. For example, different organizations may use different special keywords (e.g., warning, caution, note, etc.) that should be boosted. Further, certain types of text formatting (e.g., italics, underline, bold, font color, font size, etc.) may have different meaning or significance in documents produced by different organizations, or for different document types produced by the same or different organizations. Various other examples are possible.

In some embodiments, boosting factors are applied per document corpus. One method for assigning or adjusting the boosting factors for various content formatting tags can be based on their frequency in a document corpus, such that content formatting tags with a lower frequency are assigned higher boosting factors. For example, the font size distribution in different document corpuses may be considered to generate a histogram to assign each font size a boosting factor that is inversely proportional to its frequency or relative number of occurrences. This idea resembles statistical methods such as Term Frequency-Inverse Document Frequency (TF-IDF), a bag-of-words retrieval function such as BM25, etc., and can use similar formula although the weight (measure of importance) is assigned not to individual words or terms, and is instead assigned to the various special content formatting tags described above including those shown in the table 300 of FIG. 3. This can be done by aggregating (e.g., averaging) the weights assigned to all the words associated with a category (e.g., a special content formatting tag). The boosting factors may be calculated on-the-fly while ingesting input documents.

Boosting factors, in some embodiments, are assigned per document as specific documents may exhibit very different behavior than the entire document corpus or industry standard. For example, documents related to code often use different font families and a uniform font size. Thus, boosting factors may be assigned or adjusted for individual documents or classes of documents (e.g., user manuals, knowledge base (KB) articles, support tickets, scripts, etc.). Alternatively, the boosting factors may be compared for each document to the ones calculated for the entire document corpus. If they are significantly different, document-specific boosting factors may be used instead of corpus-wide boosting factors.

In some embodiments, semantic tags such as NER are also used. In addition to content formatting tags based on document formatting comprehension (e.g., the content formatting tags discussed above with respect to the table 300 of FIG. 3), boosting factors may also be assigned based on semantic tags. One example of semantic tags is NER. NER tagging adds predefined categorical labels to text elements, such as a “person” (e.g., John Smith), an “organization” (e.g., Dell), a “location” (e.g., New York City), and a “time” (e.g., Sep. 1, 2024). Based on such semantic tags, boosting factors may be assigned to associated text elements using a boosting value configuration file.

To complement automated methods for assigning boosting weights as described above, some embodiments also allow users (e.g., customers, administrators, etc.) to set or adjust the associated boosting factors and logic based on the users' knowledge of the RAG document corpus, the users' needs and preferences, feedback provided by users as the system is used over time, etc.

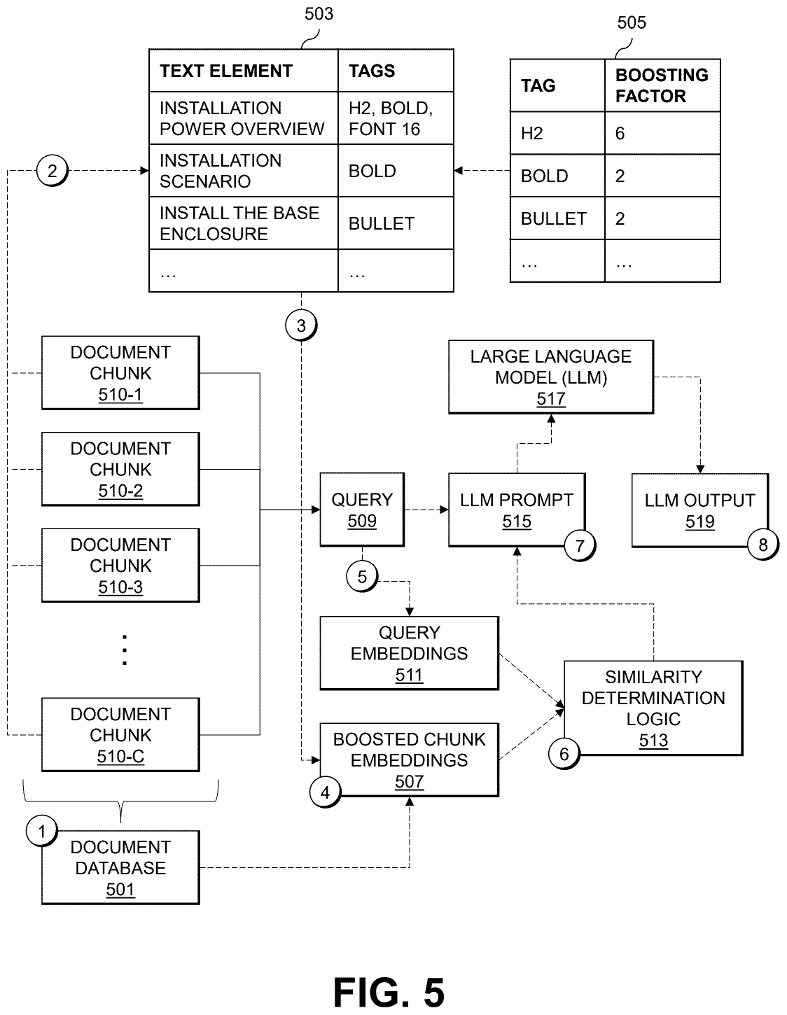

FIG. 5 shows a system flow 500 configured for implementing an enhanced RAG approach with document formatting comprehension. The system flow 500 includes the following steps:
1. Ingesting a collection of one or more input documents from a document database 501, and breaking down the input documents into document chunks 510-1, 510-2, 510-3, . . . 510-C (collectively, document chunks 510).
2. Each of the documents chunks 510 is processed to perform formatting-based document chunk boosting. Each non-default text element (e.g., text elements with one or more types of formatting associated with content formatting tags with boosted weights) is associated with the relevant content formatting tags and their boosting factors. This is illustrated in table 503.
3. The boosting factors for each of the content formatting tags of each of the non-default text elements are combined to calculate the total boosting factor for each of the non-default text elements. This is illustrated in table 505.
4. Each of the document chunks 510 is indexed using a chunk synopsis that is based on boosted vector embeddings to generate boosted chunk embeddings 507. For example, the JINA sentence transformer uses a space of 768 embeddings. The text of each chunk synopsis may be passed through a transformer that outputs a boosted vector of 768 numbers corresponding to the 768 dimensions. The content synopses and their vector embeddings may be stored in the document database 501.
5. Given a user query 509, the query text is transformed into a similar, but not boosted, vector of query embeddings 511.
6. The similarity between the user query 509 (e.g., the query embeddings 511) and the “boosted” document chunks 510 (e.g., the boosted chunk embeddings 507) is then determined utilizing similarity determination logic 513 to find a small set of the document chunks 510 that are most similar (e.g., relevant) to the user query 509. The similarity determination logic 513 may utilize a cosine similarity metric or other suitable similarity metrics. The similarity determination logic 513 may be executed efficiently using vector search functionality. The similarity determination logic 513 selects the top N matching document chunks 510.
7. The user query 509 and the selected ones of the document chunks 510 are combined to form an LLM prompt 515.
8. The LLM prompt 515 is processed by an LLM 517, which produces LLM output 519.

Various examples will now be described with respect to use of a user manual “Dell PowerStore Installation and Service Guide for PowerStore 1000, 1200, 3000, 3200, 5000, 5200, 7000, 9000 and 9200” which is about 200 pages in length. This document is parsed into a DOM structure with H1 and H2 headings along with the corresponding text in each section. Boosted vector embeddings are generated using 768-dimensional JINA embeddings.

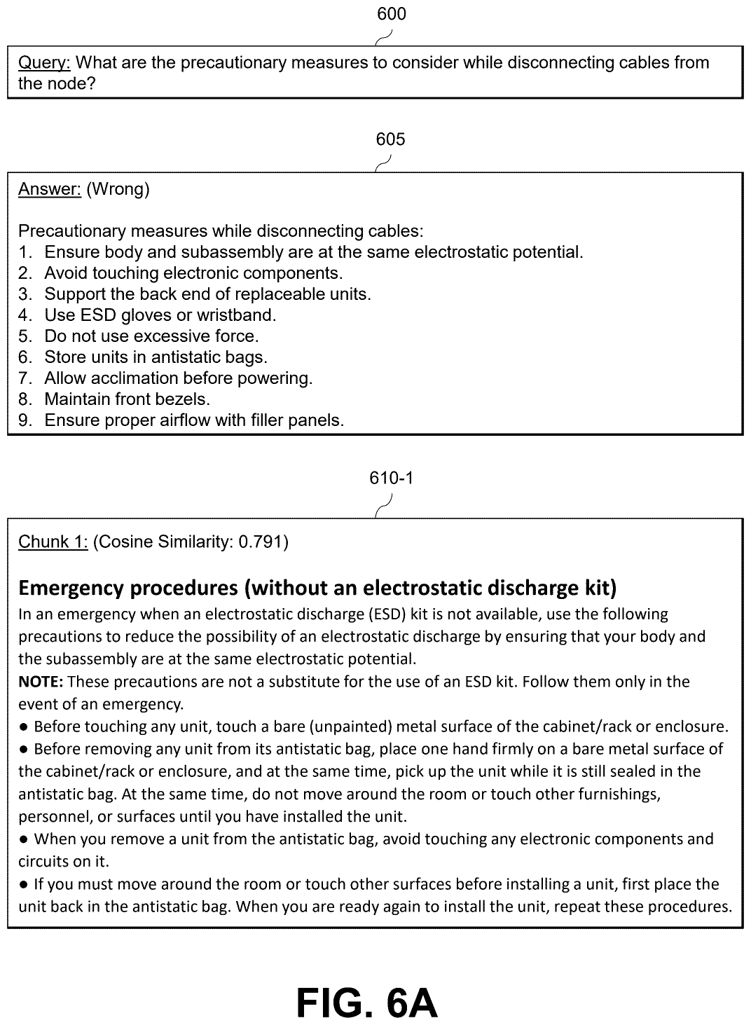

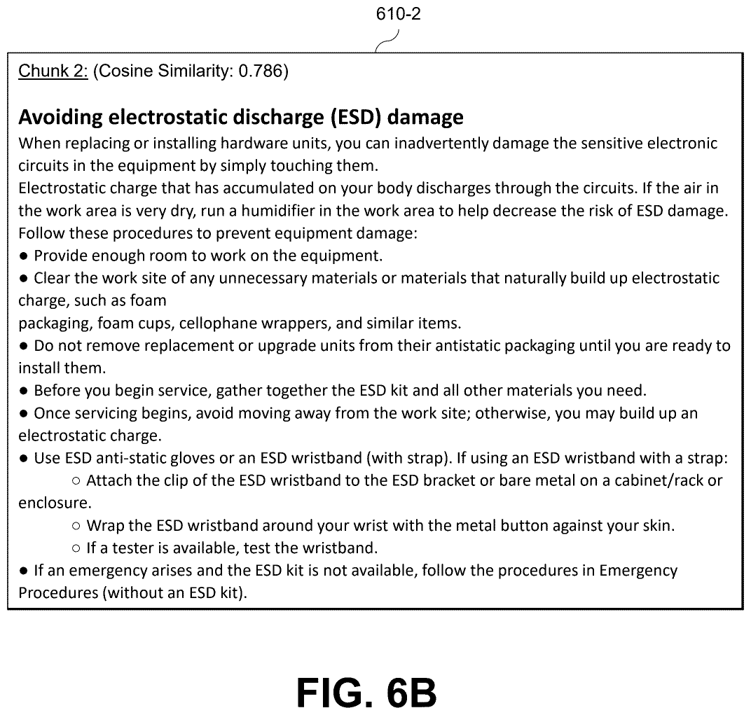

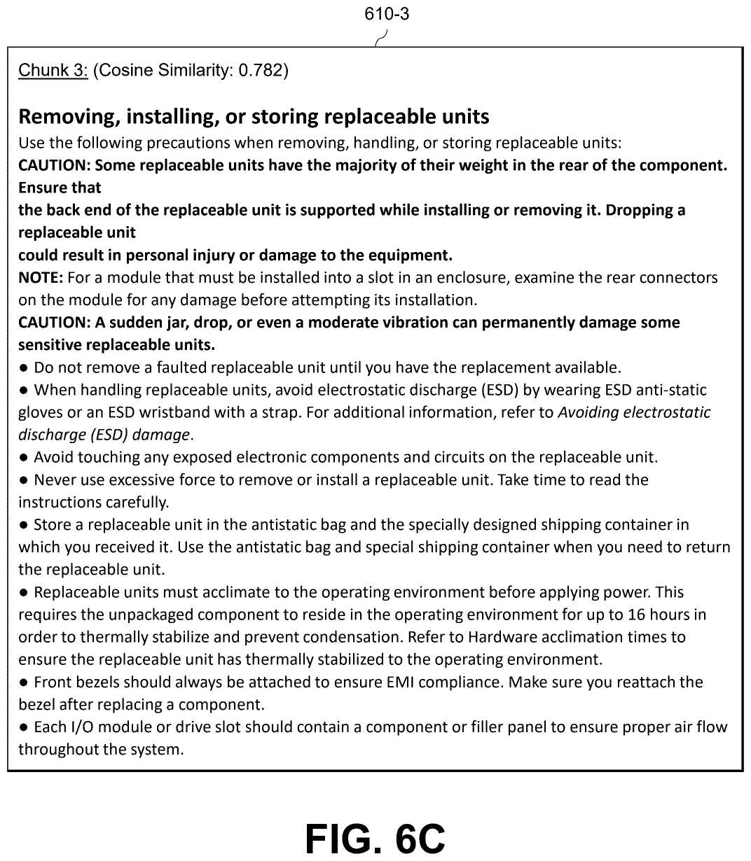

FIGS. 6A-6C show an example of a query 600 and a “wrong” answer 605 provided using a conventional RAG approach, where the query 600 is passed along with a set of document chunks 610-1, 610-2 and 610-3 (collectively, document chunks 610) to an LLM that produces the answer 605. Each of the document chunks 610 is associated with a similarity metric (e.g., a cosine similarity value between chunk embeddings and query embeddings for the query 600) which does not take into account formatting of the text of the document chunks 610.

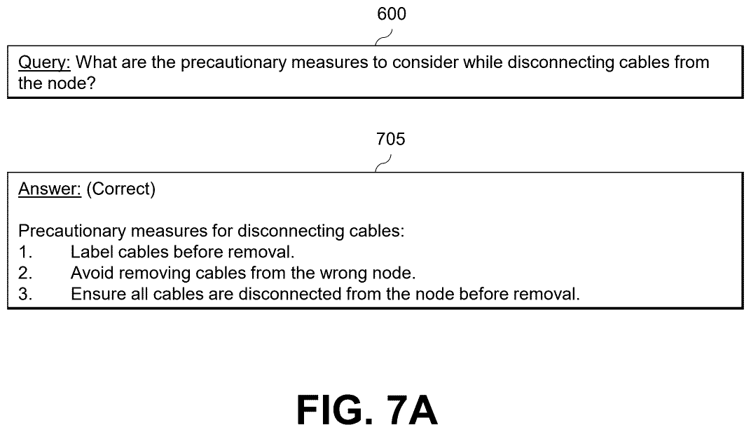

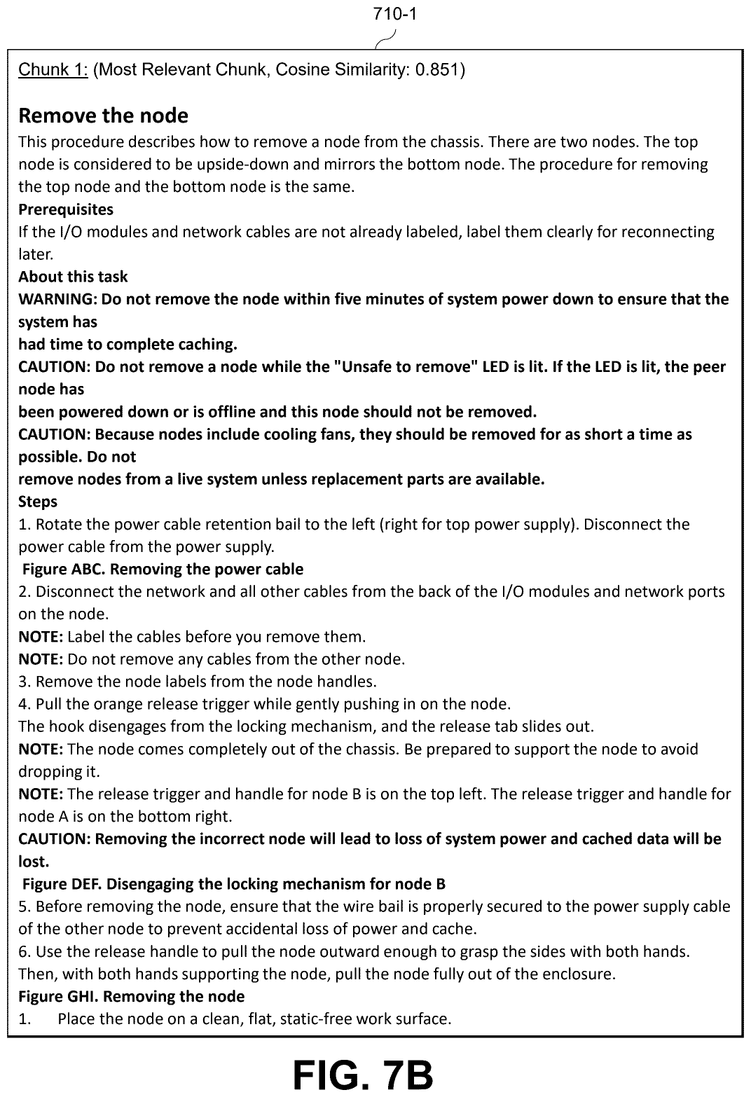

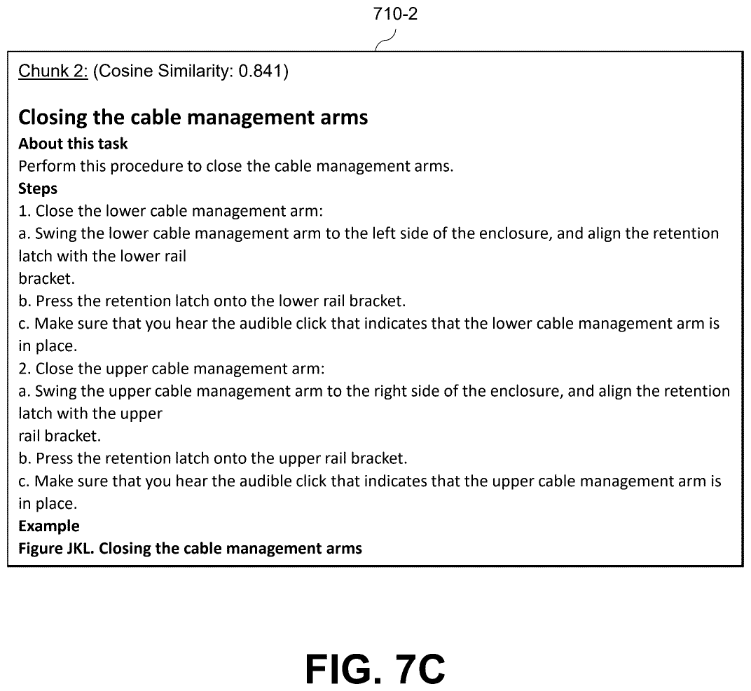

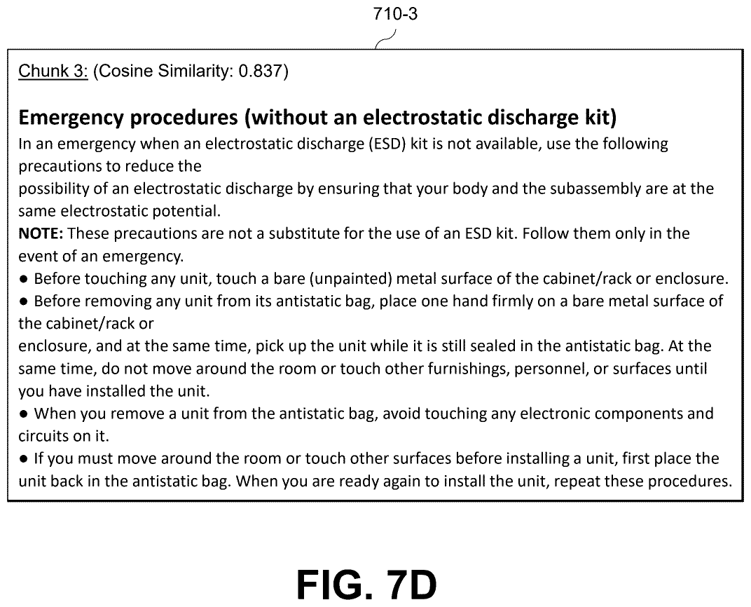

FIGS. 7A-7D show an example with the same query 600 and a “correct” answer 705 provided using the enhanced RAG approach with document formatting comprehension (e.g., formatting-based document chunk boosting), where the query 600 is passed along with a set of document chunks 710-1, 710-2 and 710-3 (collectively, document chunks 710) to an LLM that produces the answer 705. The document chunks 710 are selected based at least in part on boosting weights assigned to the document chunks 710 (e.g., using the system flow 500 of FIG. 5 to determine similarity metrics such as cosine similarity values between “boosted” chunk embeddings and query embeddings for the query 600). As illustrated, the document chunks 710 selected using the enhanced RAG approach with document formatting comprehension are different than the document chunks 610 selected using the conventional RAG approach. The selected document chunks 710 are advantageously more relevant to the query 600 than the selected document chunks 610, such that the “correct” answer 705 is produced.

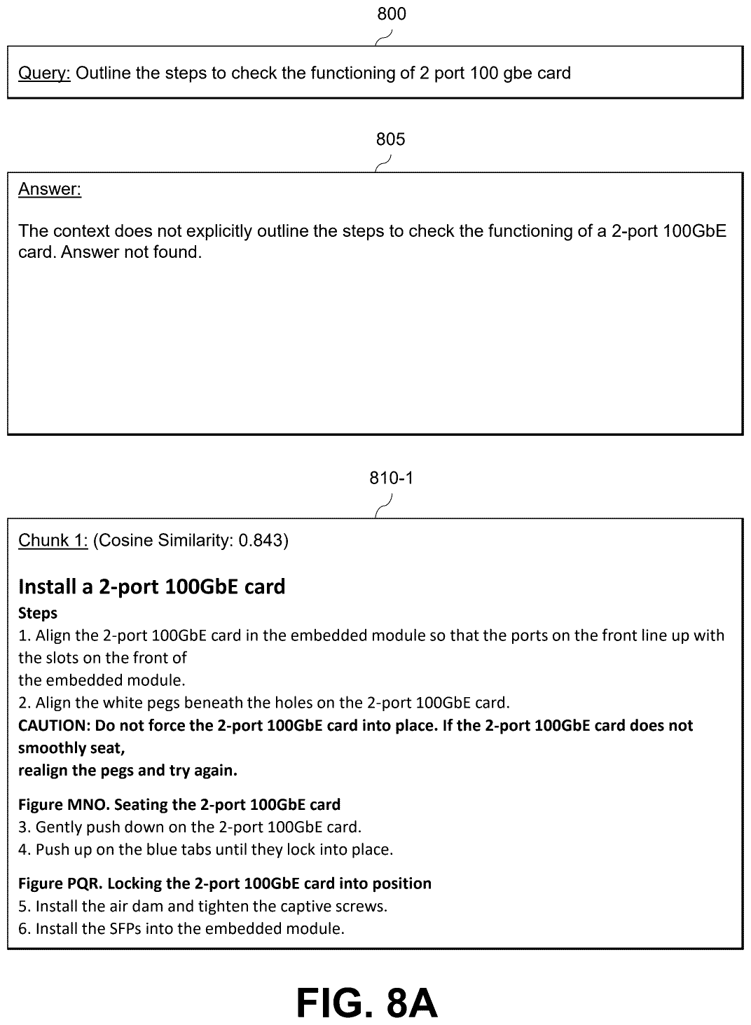

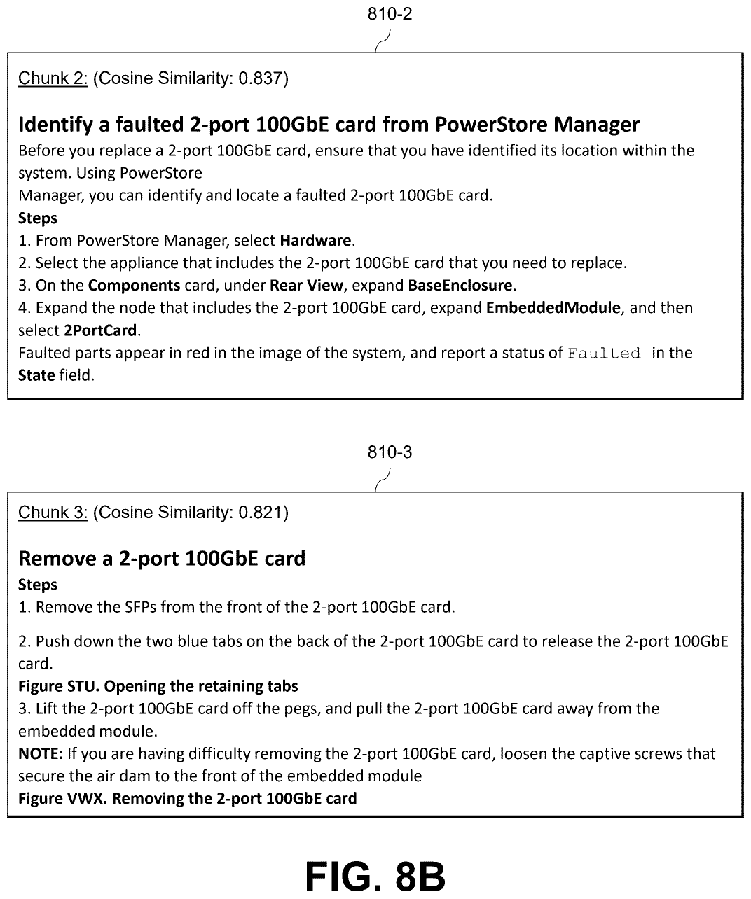

FIGS. 8A and 8B show another example of a query 800 and a “wrong” answer 805 provided using a conventional RAG approach, where the query 800 is passed along with a set of document chunks 810-1, 810-2 and 810-3 (collectively, document chunks 810) to an LLM that produces the answer 805. Each of the document chunks 810 is associated with a similarity metric (e.g., a cosine similarity value between chunk embeddings and query embeddings for the query 800) which does not take into account formatting of the text of the document chunks 810. Here, the answer 805 is not found, as no relevant context is provided by the document chunks 810.

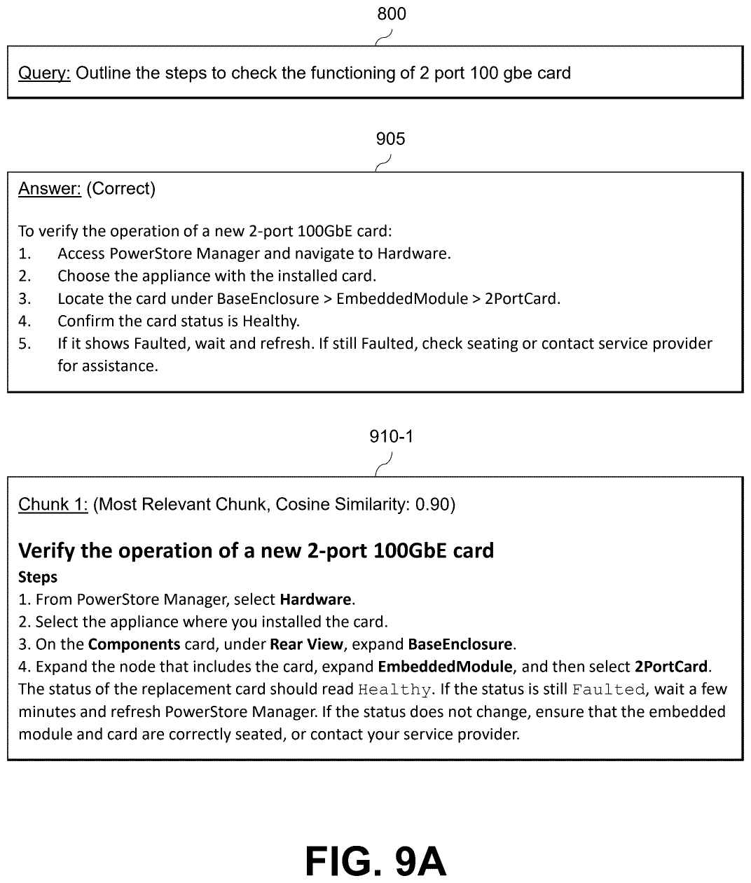

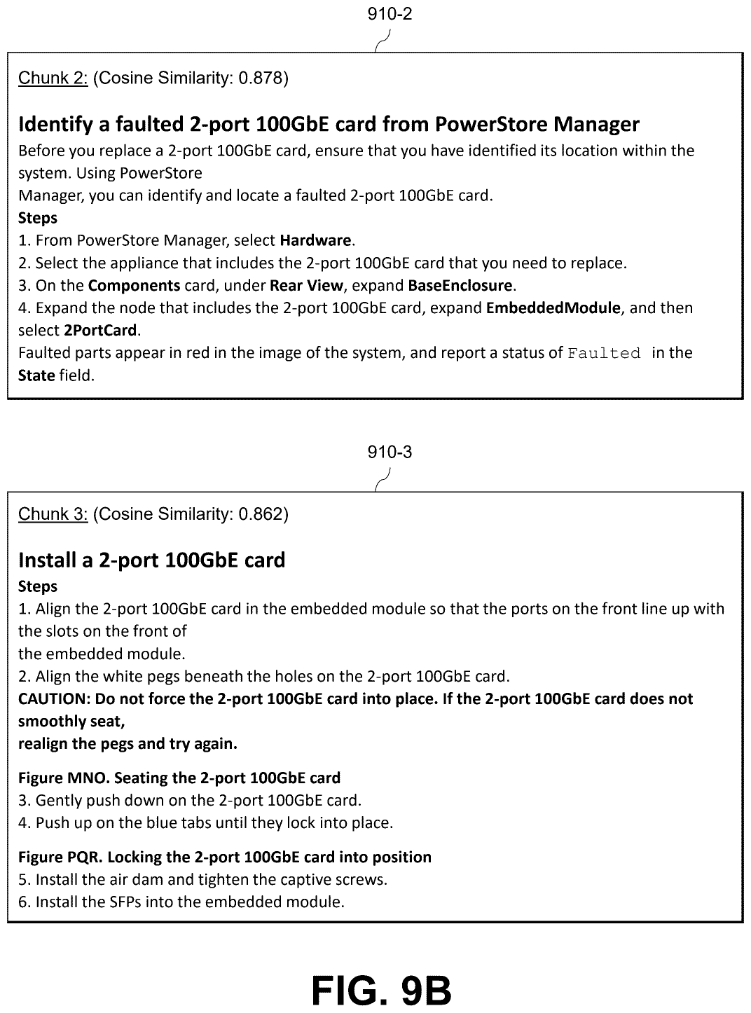

FIGS. 9A and 9B show an example with the same query 800 and a “correct” answer 905 provided using the enhanced RAG methodology with document formatting comprehension (e.g., formatting-based document chunk boosting), where the query 800 is passed along with a set of document chunks 910-1, 910-2 and 910-3 (collectively, document chunks 910) to an LLM that produces the answer 905. The document chunks 910 are selected based at least in part on boosting weights assigned to the document chunks 910 (e.g., using the system flow 500 of FIG. 5 to determine similarity metrics such as cosine similarity values between “boosted” chunk embeddings and query embeddings for the query 800). As illustrated, the document chunks 910 selected using the enhanced RAG approach with document formatting comprehension are partially different than the document chunks 810 selected using the conventional RAG approach (the document chunks 910-2 and 910-3 are the same as the document chunks 810-2 and 810-1, respectively, though their computed similarities are different). The selected document chunks 910 are advantageously more relevant to the query 800 than the selected document chunks 810, such that the “correct” answer 905 is produced.

The technical solutions described herein advantageously provide novel and innovative approaches for enhancing LLMs to provide users with relevant answers based on document formatting comprehension (e.g., formatting of textual content).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based query processing of documents based on document formatting of textual elements will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based query processing of documents based on document formatting of textual elements as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. An apparatus comprising:
at least one processing device comprising a processor coupled to a memory;
the at least one processing device being configured:
to obtain a query, the query comprising search text and a context, the context identifying one or more documents to be searched using the search text;
to generate a plurality of document chunks by parsing the one or more documents, each of the plurality of document chunks comprising a portion of content of one of the one or more documents;
to determine one or more chunk boosting factors for at least a subset of the plurality of document chunks, the one or more chunk boosting factors being determined based at least in part on document formatting-based textual element boosting factors of textual elements within the subset of the plurality of document chunks, each of the document formatting-based textual element boosting factors characterizing whether a given textual element utilizes a given one of two or more different types of document formatting;
to select a subset of the plurality of document chunks based at least in part on determining a similarity between content of the plurality of document chunks and the search text, the determined similarity being based at least in part on the determined one or more chunk boosting factors for the subset of the plurality of document chunks;
to generate, based at least in part on the query, a prompt for input to a machine learning system, the prompt comprising the selected subset of the plurality of document chunks;
to apply the prompt to the machine learning system to generate an output; and
to provide an answer to the query based at least in part on the output of the machine learning system.

2. The apparatus of claim 1 wherein the two or more different types of document formatting comprise text with a designated heading style, at least a designated font size, text emphasis and text color.

3. The apparatus of claim 1 wherein the two or more different types of document formatting comprise text that is part of a numbered list and text that is part of a bulleted list.

4. The apparatus of claim 1 wherein the one or more chunk boosting factors are further based at least in part on whether the textual elements within the subset of the plurality of document chunks contain one or more designated keywords.

5. The apparatus of claim 1 wherein a given document chunk in the subset of document chunks comprises two or more textual elements each associated with at least one of the document formatting-based textual element boosting factors, the one or more chunk boosting factors for the given document chunk being based at least in part on a combination of the document formatting-based textual element boosting factors of the two or more textual elements in the given document chunk.

6. The apparatus of claim 5 wherein a given one of the two or more textual elements in the given document chunk is associated with two or more of the document formatting-based textual element boosting factors.

7. The apparatus of claim 1 wherein the one or more chunk boosting factors are based at least in part on frequencies of use of the two or more different types of document formatting in the textual elements in the one or more documents.

8. The apparatus of claim 1 wherein the one or more chunk boosting factors are document-specific for a given one of the one or more documents.

9. The apparatus of claim 1 wherein the one or more chunk boosting factors are document-specific for a given one of the one or more documents responsive to determining that frequencies of use of the two or more different types of document formatting in textual elements in the given document exhibit at least a threshold difference from frequencies of use of the two or more different types of document formatting in textual elements in one or more other ones of the one or more documents.

10. The apparatus of claim 1 wherein the one or more chunk boosting factors utilized for a given one of the one or more documents are based at least in part on at least one of an entity that produced the given document and a document type of the given document.

11. The apparatus of claim 1 wherein the one or more chunk boosting factors are further determined based at least in part on named entity recognition in the textual elements within the subset of the plurality of document chunks.

12. The apparatus of claim 1 wherein the machine learning system comprises a large language model.

13. The apparatus of claim 1 wherein the query is directed to performing configuration of an information technology asset, and wherein the one or more documents comprise one or more technical guides for the information technology asset.

14. The apparatus of claim 1 wherein the query is directed to performing at least one of troubleshooting and remediation of one or more issues encountered on an information technology asset, and wherein the one or more documents comprise one or more support tickets associated with the one or more issues encountered on the information technology asset.

15. A computer program product comprising a non-transitory processor-readable storage medium having stored therein program code of one or more software programs, wherein the program code when executed by at least one processing device causes the at least one processing device:
to obtain a query, the query comprising search text and a context, the context identifying one or more documents to be searched using the search text;
to generate a plurality of document chunks by parsing the one or more documents, each of the plurality of document chunks comprising a portion of content of one of the one or more documents;
to determine one or more chunk boosting factors for at least a subset of the plurality of document chunks, the one or more chunk boosting factors being determined based at least in part on document formatting-based textual element boosting factors of textual elements within the subset of the plurality of document chunks, each of the document formatting-based textual element boosting factors characterizing whether a given textual element utilizes a given one of two or more different types of document formatting;
to select a subset of the plurality of document chunks based at least in part on determining a similarity between content of the plurality of document chunks and the search text, the determined similarity being based at least in part on the determined one or more chunk boosting factors for the subset of the plurality of document chunks;
to generate, based at least in part on the query, a prompt for input to a machine learning system, the prompt comprising the selected subset of the plurality of document chunks;
to apply the prompt to the machine learning system to generate an output; and
to provide an answer to the query based at least in part on the output of the machine learning system.

16. The computer program product of claim 15 wherein a given document chunk in the subset of document chunks comprises two or more textual elements each associated with at least one of the document formatting-based textual element boosting factors, the one or more chunk boosting factors for the given document chunk being based at least in part on a combination of the document formatting-based textual element boosting factors of the two or more textual elements in the given document chunk.

17. The computer program product of claim 15 wherein the one or more chunk boosting factors utilized for a given one of the one or more documents are based at least in part on at least one of an entity that produced the given document and a document type of the given document.

18. A method comprising:
obtaining a query, the query comprising search text and a context, the context identifying one or more documents to be searched using the search text;
generating a plurality of document chunks by parsing the one or more documents, each of the plurality of document chunks comprising a portion of content of one of the one or more documents;
determining one or more chunk boosting factors for at least a subset of the plurality of document chunks, the one or more chunk boosting factors being determined based at least in part on document formatting-based textual element boosting factors of textual elements within the subset of the plurality of document chunks, each of the document formatting-based textual element boosting factors characterizing whether a given textual element utilizes a given one of two or more different types of document formatting;
selecting a subset of the plurality of document chunks based at least in part on determining a similarity between content of the plurality of document chunks and the search text, the determined similarity being based at least in part on the determined one or more chunk boosting factors for the subset of the plurality of document chunks;
generating, based at least in part on the query, a prompt for input to a machine learning system, the prompt comprising the selected subset of the plurality of document chunks;
applying the prompt to the machine learning system to generate an output; and
providing an answer to the query based at least in part on the output of the machine learning system;
wherein the method is performed by at least one processing device comprising a processor coupled to a memory.

19. The method of claim 18 wherein a given document chunk in the subset of document chunks comprises two or more textual elements each associated with at least one of the document formatting-based textual element boosting factors, the one or more chunk boosting factors for the given document chunk being based at least in part on a combination of the document formatting-based textual element boosting factors of the two or more textual elements in the given document chunk.

20. The method of claim 18 wherein the one or more chunk boosting factors utilized for a given one of the one or more documents are based at least in part on at least one of an entity that produced the given document and a document type of the given document.
